(19) United States
(12) Patent Application Publication
(10) Pub. No.: US 2012/0089863 A1
(43) Pub. Date: Apr. 12, 2012

(54) FAILOVER SYSTEM, STORAGE PROCESSING DEVICE AND FAILOVER CONTROL METHOD

(75) Inventors: Satoru GOTO, Nagoya-shi (JP); Yukihito Hara, Nagoya-shi (JP)

(73) Assignee: Buffalo Inc., Nagoya-shi (JP)

(21) Appl. No.: 13/268,283

(22) Filed: Oct. 7, 2011

(30) Foreign Application Priority Data
Oct. 8, 2010 (JP) 2010-228491

(51) Int. Cl. G06F 11/20

(52) U.S. Cl. 714/4.11; 714/E11.073; 714/E11.089

(57) ABSTRACT

A NAS as a main machine transmits a search packet for searching for a NAS as a new backup machine when a response from a NAS as a backup machine is not received. Each of NAS receiving the search packet transmits a device information packet to the NAS as the main machine. The device information packet includes a version number of failover function and storage capacity information. The NAS as the main machine selects a NAS as the new backup machine based on the version number and the storage capacity information included in the device information packet.

### CROSS REFERENCE TO RELATED APPLICATION

This application is based upon and claims the benefit of priority from the prior Japanese Patent Application No. 2010-228491 filed on Oct. 8, 2010; all the contents of which are incorporated herein by reference.

### BACKGROUND OF INVENTION

1. Field of Invention

This invention relates to a failover system including storage processing devices to which storage media are connectable, a storage processing device in the failover system, and a failover control method for the storage processing device.

2. Description of Related Art

There have heretofore been cases where the failover configuration is adopted to improve the system reliability. In a system adopting the failover configuration (failover system), one of two servers serves as a main machine and the other serves as a backup machine, for example. The server as the main machine usually processes tasks. When a failure occurs in the server as the main machine, the server as the backup machine takes over the tasks of the main machine (see, e.g. Japanese Patent No. 4457184 and Japanese Patent Application Publication No. 2010-128644).

Meanwhile, storage processing device called a network attached storage (NAS) has recently come into use. The NAS can have plural hard disks connected thereto, and can store various content data such as video and audio data in the hard disks. When receiving a request for content data from a terminal device through the network, the NAS transmits the requested content data to the terminal device through the network. The terminal device reproduces the content of the received content data.

It has been proposed to build a failover configuration also in such a system using the NAS. When the failover system includes two NAS, one of the NAS serves as a main machine and the other serves as a backup machine. As with the above, the NAS as the main machine usually processes the tasks. When a failure occurs in the NAS as the main machine, the NAS as the backup machine takes over the tasks of the NAS as the main machine.

### SUMMARY OF INVENTION

However, if a failover system including two NAS has a failure in the NAS as the backup machine, a new NAS needs to be set up as a backup machine for the failover system. Such setting and other necessary work, however, needs to depend on manpower and takes time.

In consideration of the foregoing problems, it is an object of this invention to provide a failover system, a storage processing device and a failover control method, which are capable of easily constructing a failover configuration.

In order to solve the problem mentioned above, this invention has the following features.

According to one of the features of this invention, there is provided a failover system comprising: a first storage processing device (NAS 10) to which a storage medium (hard disk 151, hard disk 152) is connectable; a second storage processing device (NAS 20) to which a storage medium is connectable, and which serves as a backup machine for the first storage processing device when a failure occurs in the first storage processing device; and third storage processing devices (NAS 30, NAS 40, NAS 50) to which storage media are connectable, and which are candidates for a backup machine, wherein the first storage processing device comprises: a presence confirmation information transmitter (presence confirmation processor 161) for transmitting, to the second storage processing device, presence confirmation information (echo request packet) for confirming the presence of the second storage processing device; a first response information receiver (presence confirmation processor 161) for receiving first response information (echo reply packet) that is a response to the presence confirmation information from the second storage processing device; and a search information transmitter (search packet transmission processor 162) for transmitting search information (search packet) for searching for the third storage processing devices when the first response information is not received within a predetermined period after the transmission of the presence confirmation information, each of the third storage processing devices comprises: a search information receiver (search packet reception processor 361) for receiving the search information; and a response information transmitter (response information transmission processor 363) for transmitting second response information (device information packet or determination result packet) that is a response to the search information, and the first storage processing device further comprises: a second response information receiver (response information reception processor 163) for receiving the second response information from the third storage processing devices, and a selector (backup machine selector 164) for selecting a backup machine from among the third storage processing devices based on the second response information received by the second response information receiver.

In the above failover system, when the first storage processing device as the main machine can no longer confirm the presence of the second storage processing device as the backup machine, the first storage processing device transmits a search packet for searching for the third storage processing devices. Meanwhile, the third storage processing device transmits, to the first storage processing device, second response information that is a response to the search information. Accordingly, the first storage processing device receives the second response information and thus can select a new backup machine based on the second response information. Thus, a failover configuration can be easily constructed without depending on manpower.

According to one of the features of this invention, the search information is information requesting transmission of at least any one of a function required to construct a failover configuration, a RAID configuration, and a storage capacity of a storage medium, and the second response information includes at least any one of: the function required to construct the failover configuration in a third storage processing device transmitting the second response information; the RAID configuration in the third storage processing device; and the storage capacity of the storage medium in the third storage processing device.

According to one of the features of this invention, the search information includes at least any one of a function required to construct a failover configuration, a RAID configuration, and the amount of data to be synchronized, and the second response information includes determination result information that is a result of determination of whether a third storage processing device transmitting the second response information is operable as the backup machine, the determination being made based on at least any one of the function required to construct the failover configuration, the RAID configuration, and the amount of data to be synchronized.

According to one of the features of this invention, there is provided a storage processing device to which a storage medium is connectable, and which serves as a main machine in a failover system, comprising: a presence confirmation information transmitter for transmitting, to a first different storage processing device as a backup machine, presence confirmation information for confirming the presence of the first different storage processing device; a first response information receiver for receiving first response information that is a response to the presence confirmation information from the first different storage processing device; a search information transmitter for transmitting search information for searching for second different storage processing devices that are candidates for a backup machine when the response information is not received within a predetermined period after the transmission of the presence confirmation information; a second response information receiver for receiving second response information that is a response to the search information from each of the second different storage processing devices; and a selector for selecting a backup machine from among the second different storage processing devices based on the second response information received by the second response information receiver.

According to one of the features of this invention, there is provided a storage processing device to which a storage medium is connectable, and which is a candidate for a backup machine in a failover system, comprising: a search information receiver for receiving search information for searching for the own storage processing device from a different storage processing device; and a response information transmitter for transmitting response information that is a response to the search information, the response information including at least any one of a function required to construct a failover configuration and a storage capacity of the storage medium in the own storage processing device, or including determination result information that is a result of determination of whether the own storage processing device is operable as the backup machine.

According to one of the features of this invention, there is provided a failover control method in a storage processing device to which a storage medium is connectable, and which serves as a main machine in a failover system, comprising the steps of: transmitting, to a first different storage processing device as a backup machine, presence confirmation information for confirming the presence of the first different storage processing device; receiving first response information that is a response to the presence confirmation information from the first different storage processing device; transmitting search information for searching for second different storage processing devices that are candidates for a backup machine when the response information is not received within a predetermined period after the transmission of the presence confirmation information; receiving second response information that is a response to the search information from each of the second different storage processing devices; and selecting a backup machine from among the second different storage processing devices based on the received second response information.

According to one of the features of this invention, there is provided a failover control method in a storage processing device to which a storage medium is connectable, and which is a candidate for a backup machine in a failover system, comprising the steps of: receiving search information for searching for the own storage processing device from a different storage processing device; and transmitting response information that is a response to the search information, the response information including at least any one of a function required to construct a failover configuration and a storage capacity of the storage medium in the own storage processing device, or including determination result information that is a result of determination of whether or not the own storage processing device is operable as the backup machine.

### BRIEF DESCRIPTION OF DRAWINGS

FIG. 1 schematically shows the entire failover system according to an embodiment of this invention.

FIG. 2 schematically shows a first NAS according to the embodiment of this invention.

FIG. 3 schematically shows a second NAS according to the embodiment of this invention.

FIG. 4 schematically shows a third NAS according to the embodiment of this invention.

FIG. 5 is a sequence diagram showing a first operation of the failover system according to the embodiment of this invention.

FIG. 6 is a sequence diagram showing a second operation of the failover system according to the embodiment of this invention.

### DESCRIPTION OF EMBODIMENTS

Next, an embodiment of this invention is described with reference to the drawings. To be more specific, description is given of Configuration of Failover System, Configuration of NAS, Operation of Failover System, Obtained Result, and

Other Embodiments. In the drawings, the same or similar components are labeled with the same or similar reference numerals.

(1) Configuration of Failover System

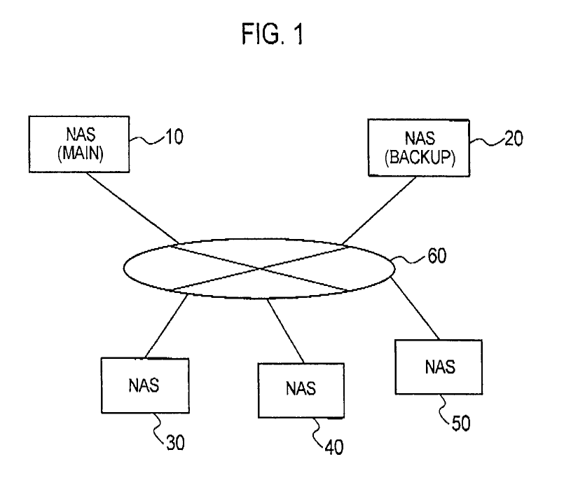

FIG. 1 schematically shows the entire failover system. The failover system shown in FIG. 1 includes NAS (Network Attached Storages) 10, 20, 30, 40 and 50 as storage processing devices, and a communication network 60 for connecting the NAS 10 to 50.

In the failover system of this embodiment, the NAS 10 serves as a main machine and the NAS 20 serves as a backup machine. The NAS 10 and 20 are synchronized in terms of settings and data. The NAS 10 as the main machine usually processes tasks. When a failure occurs in the NAS 10 as the main machine, the NAS 20 as the backup machine takes over the tasks of the NAS 10. The NAS 30 to 50 are candidates for the backup machine. In this embodiment, the NAS 10 corresponds to the first storage processing device. The NAS 20 corresponds to the second storage processing device. The NAS 30 to 50 correspond to the third storage processing devices.

(2) Configuration of NAS

(2-1) Configuration of NAS as Main Machine

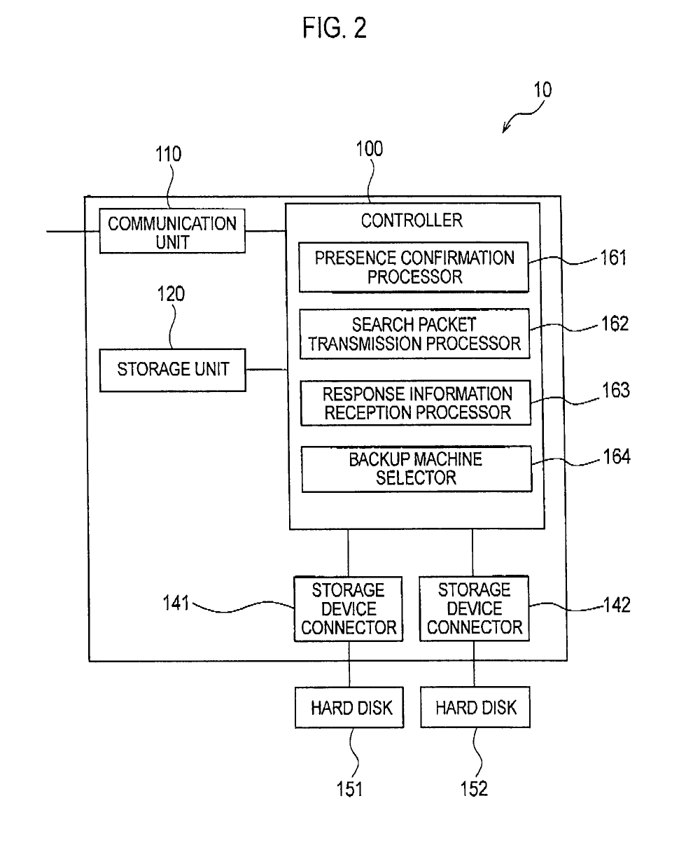

FIG. 2 schematically shows the NAS 10 as the main machine in the failover system. The NAS 10 shown in FIG. 2 includes a controller 100, a communication unit 110, a storage unit 120, a storage device connector 141 and a storage device connector 142.

The controller 100 is, for example, a CPU, and controls various functions included in the NAS 10.

The communication unit 110 is, for example, a LAN card, which has a MAC (Media Access Control) address assigned thereto. The communication unit 110 is a communication interface for communicating with the outside, and communicates with the NAS 20 to 50 through the communication network 60.

The storage unit 120 is, for example, an NAND flash memory, and stores various information to be used for control and the like in the NAS 10. To be more specific, the storage unit 120 stores various setting information required for the failover configuration. The storage device connector 141 connects a hard disk 151 to the NAS 10. The storage device connector 142 connects a hard disk 152 to the NAS 10. The hard disks 151 and 152 construct a RAID configuration, and store data, such as user data, to be synchronized between the main machine and the backup machine.

The controller 100 includes a presence confirmation processor 161, a search packet transmission processor 162, a response information reception processor 163, and a backup machine selector 164.

The presence confirmation processor 161 uses a ping to confirm the presence of the NAS 20 as the backup machine. To be more specific, the presence confirmation processor 161 generates ICMP (Internet Control Message Protocol) echo request packet for the NAS 20 at predetermined intervals, and outputs the packet to the communication unit 110. The communication unit 110 transmits the echo request packet received to the NAS 20 through the communication network 60. In this embodiment, the echo request packet corresponds to the presence confirmation information.

Upon receipt of the echo request packet, the NAS 20 transmits an echo reply packet, which is a response to the echo request packet, to the NAS 10 through the communication network 60. In this embodiment, the echo reply packet from NAS 20 corresponds to the first response information.

The communication unit 110 in the NAS 10 receives the echo reply packet and outputs the packet to the controller 100. Upon receipt of the echo reply packet, the presence confirmation processor 161 in the controller 100 considers that the presence of the NAS 20 is confirmed.

There is, on the other hand, a case where the echo request packet from the NAS 10 does not reach the NAS 20 or a case where the echo request packet from the NAS 20 does not reach the NAS 10, due to a failure in the NAS 20 or a failure in the link between the NAS 10 and the NAS 20. In such a case, the presence confirmation processor 161 cannot receive an echo reply packet within a predetermined period after transmitting the echo request packet.

The presence confirmation processor 161 determines whether or not it has received the echo reply packet within the predetermined period after transmitting the echo request packet, in other words, whether or not it has received a response from the NAS 20.

When there is no response from the NAS 20, the search packet transmission processor 162 generates a search packet for searching for a NAS to be a new backup machine. The search packet is information requesting the NAS as a destination of the search packet to transmit a version number, a product ID and a storage capacity of a hard disk connected to the NAS. To be more specific, the version number is information allowing identification of a function required to construct a failover configuration in the NAS (failover function). Moreover, the product ID is information allowing identification of a RAID configuration that can be adopted in the hard disk connected to the NAS. In this embodiment, the search packet corresponds to the search information.

The search packet transmission processor 162 outputs the generated search packet to the communication unit 110. The communication unit 110 transmits the received search packet to the communication network 60. In this event, the communication unit 110 may broadcast-transmit the search packet or may unicast-transmit the search packet to the NAS 30 to 50 if IP addresses of the NAS 30 to 50 are known.

Upon receipt of the search packet, each of the NAS 30 to 50 transmits, as described later, a packet (device information packet) requested by the search packet to the NAS 10 through the communication network 60. To be more specific, the device information packet includes information on the version number of the failover function, the product ID and the storage capacity. In this embodiment, the device information packet corresponds to the second response information.

The communication unit 110 in the NAS 10 receives the device information packet and then outputs the packet to the controller 100. The response information reception processor 163 in the controller 100 receives the device information packet.

The backup machine selector 164 extracts the information on the version number of the failover function, the product ID and the storage capacity from the device information packet from each of the NAS 30 to 50.

The backup machine selector 164 then determines whether or not the NAS as a source of the device information packet can serve as a backup machine, based on the extracted information on the version number of the failover function, the product ID and the storage capacity.

Here, the backup machine selector 164 determines whether or not the NAS as the source of the device information packet can realize a failover configuration specified by the version number in the NAS 10. To be more specific, the storage unit 120 holds the version number in the NAS 10 and one or more other version numbers, which can realize the failover configuration corresponding to the version number, while associating the version numbers with each other. When the version number extracted from the device information packet is associated with the version number in the NAS 10 including the backup machine selector 164, the backup machine selector 164 determines the NAS as the source of the device information packet to be the one that can realize the failover configuration specified by the version number in the NAS 10.

Moreover, the backup machine selector 164 determines whether or not hard disks 351 and 352 connected to the NAS as the source of the device information packet can construct the RAID configuration constructed by the hard disks 151 and 152 connected to the NAS 10. To be more specific, the backup machine selector 164 determines whether or not the RAID configuration specified by the product ID extracted from the device information packet corresponds to the RAID configuration constructed by the hard disks 151 and 152.

Furthermore, the backup machine selector 164 determines whether or not the storage capacity extracted from the device information packet is not less than the storage capacity required for a new failover function to be realized.

The backup machine selector 164 selects the NAS as the source of the device information packet as the backup machine if the following three conditions are met: (1) the NAS as the source of the device information packet can realize the failover configuration in the NAS 10, (2) the hard disks 351 and 352 connected to the NAS as the source of the device information packet can construct the RAID configuration constructed by the hard disks 151 and 152 connected to the NAS 10, and (3) the storage capacity extracted from the device information packet is not less than the storage capacity required for a new failover function to be realized. Note that when more than one NAS can be selected as the backup machine, the backup machine selector 164 selects any one of the NAS as the backup machine.

Furthermore, the backup machine selector 164 generates a backup selection packet indicating that the NAS has been selected as the backup machine. The backup selection packet includes synchronization information including information on settings to be synchronized between the main machine and the backup machine in the failover configuration, and directory information indicating the position of data to be synchronized. The backup machine selector 164 outputs the generated backup selection packet to the communication unit 110. The communication unit 110 transmits the backup selection packet to the NAS that is the new backup machine through the communication network 60.

(2-2) Configuration of NAS as Backup Machine

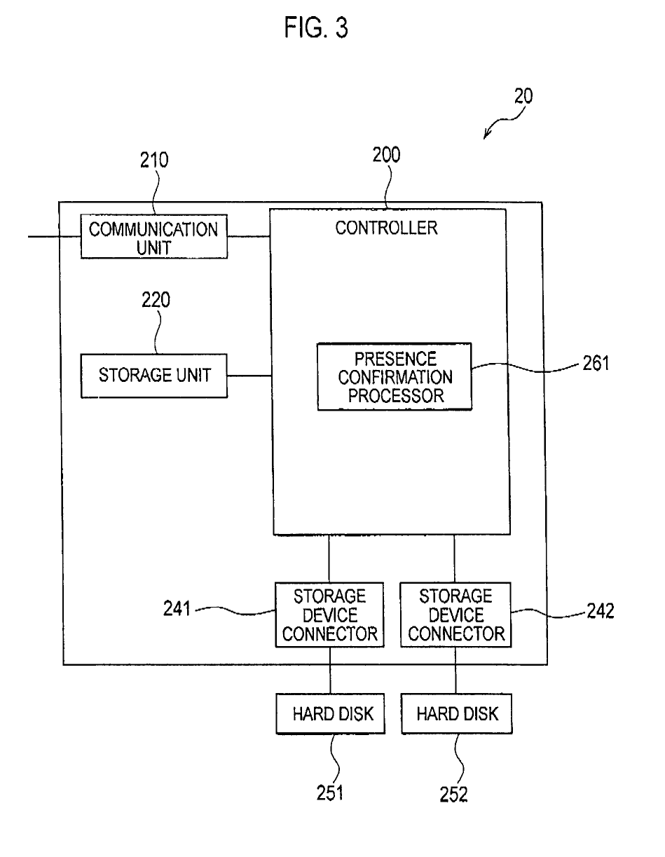

FIG. 3 schematically shows the NAS 20 as the backup machine in the failover system. The NAS 20 shown in FIG. 3 includes a controller 200, a communication unit 210, a storage unit 220, a storage device connector 241 and a storage device connector 242.

The controller 200 is, for example, a CPU, and controls various functions included in the NAS 20.

The communication unit 210 is, for example, a LAN card, which has a MAC address assigned thereto. The communication unit 210 is a communication interface for communicating with the outside, and communicates with a terminal device such as an unillustrated DMP-supporting TV set through a network, for example.

The storage unit 220 is, for example, an NAND flash memory, and stores various information to be used for control and the like in the NAS 20. To be more specific, the storage unit 220 stores various setting information required for the failover configuration. The storage device connector 241 connects a hard disk 251 to the NAS 20. The storage device connector 242 connects a hard disk 252 to the NAS 20.

(2-3) Configuration of NAS That Can be New Backup Machine

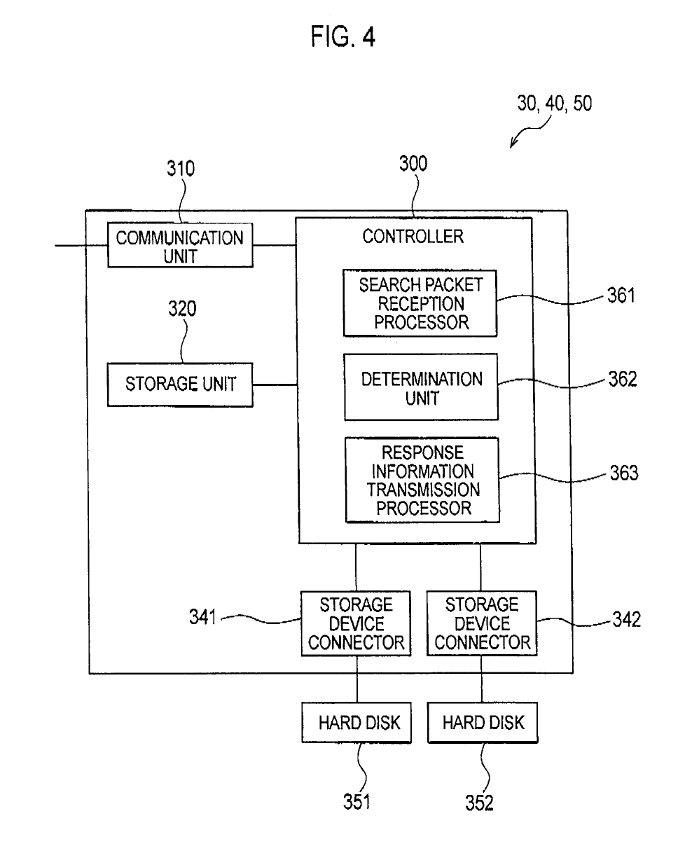

FIG. 4 schematically shows the NAS 30, 40 and 50 each capable of serving as a new backup machine in the failover system. The NAS 30 to 50 shown in FIG. 4 each include a controller 300, a communication unit 310, a storage unit 320, a storage device connector 341 and a storage device connector 342.

The controller 300 is, for example, a CPU, and controls various functions included in the NAS 30 to 50.

The communication unit 310 is, for example, a LAN card, which has a MAC address assigned thereto. The communication unit 310 is a communication interface for communicating with the outside, and communicates with a terminal device such as an unillustrated DMP-supporting TV set through a network, for example.

The storage unit 320 is, for example, an NAND flash memory, and stores various information to be used for control and the like in the NAS 30 to 50. The storage device connector 341 connects the hard disk 351 to the NAS 30 to 50. The storage device connector 342 connects the hard disk 352 to the NAS 30 to 50.

The controller 300 includes a search packet reception processor 361, a determination unit 362, and a response information transmission processor 363. Note that the determination unit 362 is the constituent component required in other embodiments to be described later, and thus description thereof is omitted in this embodiment.

The search packet reception processor 361 receives a search packet from the NAS 10 through the communication network 60 and a communication unit 310.

The response information transmission processor 363 generates a device information packet requested by the search packet received by the search packet reception processor 361. To be more specific, the device information packet includes information on a version number of a failover function of the NAS including the response information transmission processor 363, and on storage capacities of the hard disks 351 and 352. Then, the response information transmission processor 363 transmits the device information packet to the NAS 10 through the communication unit 310 and the communication network 60.

Moreover, when the NAS including the controller 300 is selected as a new backup machine, the controller 300 receives a backup selection packet from the NAS 10 through the communication network 60 and the communication unit 310. Then, the controller 300 synchronizes the settings and data, based on the synchronization information included in the backup selection packet, so that the NAS serves as the backup machine in the failover configuration.

(3) Operation of Failover System

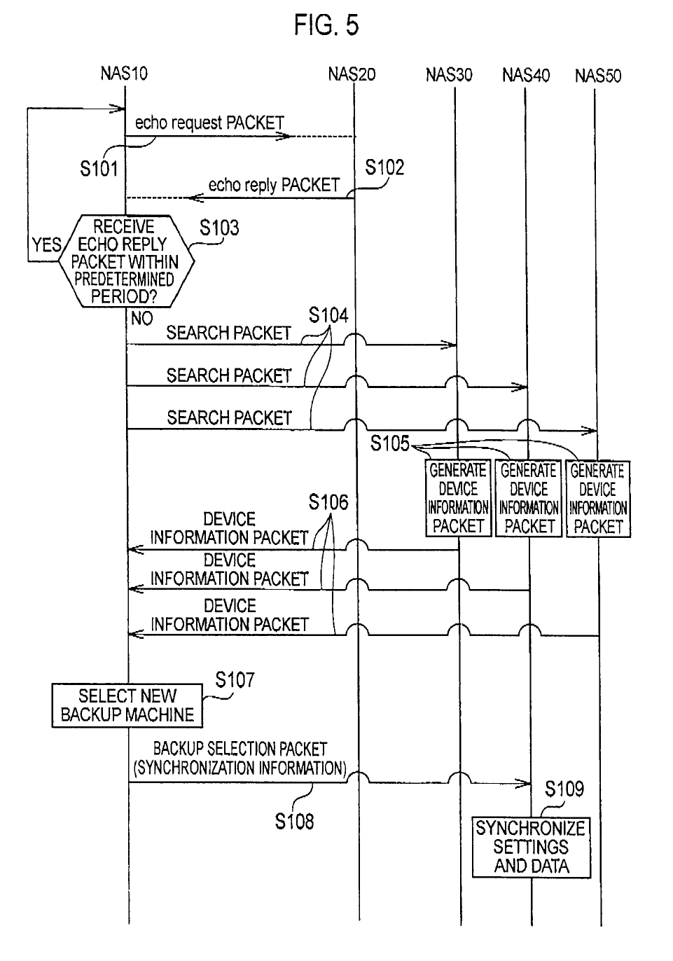

FIG. 5 is a sequence diagram showing a first operation of the failover system. In Step S101, the NAS 10 as the main machine transmits an echo request packet to the NAS 20 as the backup machine. Upon receipt of the echo request packet in Step S101, the NAS 20 transmits an echo reply packet to the NAS 10 in Step S102.

In Step S103, the NAS 10 determines whether or not it has received the echo reply packet in Step S102 within a predetermined period after transmitting the echo request packet in Step S101.

If the NAS 10 has received the echo reply packet within the predetermined period after transmitting the echo request packet, the operation after the transmission of the echo request packet in Step S101 is repeated.

On the other hand, if the NAS 10 has received no echo reply packet within the predetermined period after transmitting the echo request packet, the NAS 10 transmits, in Step S104, a search packet to each of the NAS 30 to 50 that can be candidates for the backup machine. To be more specific, the search packet includes information requesting each NAS to transmit a storage capacity and a version number that is failover function identifying information. Each of the NAS 30 to 50 receives the search packet.

In Step S105, each of the NAS 30 to 50 generates a device information packet requested by the search packet. To be more specific, the device information packet includes the version number of the failover function and the storage capacity information.

In Step S106, each of the NAS 30 to 50 transmits the device information packet to the NAS 10. The NAS 10 receives the device information packet.

In Step S107, the NAS 10 selects a NAS (here, the NAS 40) to be a new backup machine from among the NAS 30 to 50, based on the version number of the failover function and the storage capacity information, which are included in the device information packet.

In Step S108, the NAS 10 transmits a backup selection packet including synchronization information to the selected NAS 40. The NAS 40 receives the backup selection packet.

In Step S109, the NAS 40 synchronizes the settings and data for the NAS 40 to become the backup machine in the failover configuration, based on the synchronization information included in the backup selection packet. (4) Obtained Result

In the failover system of this embodiment, when there is no response from the NAS 20, the NAS 10 as the main machine transmits a search packet for searching for a NAS to be a new backup machine. Upon receipt of the search packet, each of the NAS 30 to 50 sends the NAS 10 device information packet including a version number of the failover function and storage capacity information. The NAS 10 selects a NAS to be the new backup machine based on the version number of the failover function and the storage capacity information, which are included in each device information packet, and then transmits a backup selection packet to the selected NAS. The NAS that has received the backup selection packet synchronizes the settings and data for itself to become the backup machine in the failover configuration. Accordingly, the NAS 10 can select the NAS to be the new backup machine. Thus, the failover configuration can be easily constructed without depending on manpower.

(5) Other Embodiments

As described above, the details of this invention have been disclosed by using the embodiment of this invention. However, it should not be understood that the description and drawings which constitute part of this disclosure limit this invention. From this disclosure, various alternative embodiments, examples, and operation techniques will be easily found by those skilled in the art.

In the above embodiment, each of the NAS 30 to 50 that have received the search packets sends the NAS 10 the device information packet including the version number of the failover function and storage capacity information. Then, the NAS 10 selects a NAS to be the new backup machine based on the version number of the failover function and the storage capacity information, which are included in each device information packet. However, the following method may be adopted.

That is, if the NAS 10 receives no echo reply packet within a predetermined period after transmitting the echo request packet, the search packet transmission processor 162 in the NAS 10 generates a search packet for searching for a NAS to be a new backup machine. In this embodiment, the search packet includes a version number that is information capable of identifying the failover function requested for the backup machine. Moreover, the search packet includes a product ID that is information capable of identifying the RAID configuration adopted by the hard disks 151 and 152 connected to the NAS 10. Furthermore, the search packet includes information on the amount of data to be synchronized, in other words, data stored in the hard disks 151 and 152 connected to the NAS 10 (synchronization data amount information).

The search packet transmission processor 162 outputs the generated search packet to the communication unit 110. The communication unit 110 transmits the received search packet to the communication network 60.

The search packet reception processor 361 in each of the NAS 30 to 50 receives the search packet from the NAS 10 through the communication network 60 and the communication unit 310.

When the search packet reception processor 361 has received the search packet, the determination unit 362 extracts the version number of the failover function, the product ID and the synchronization data amount information from the search packet. Then, the determination unit 362 determines whether or not the NAS including the determination unit 362 can serve as a backup machine, based on the version number of the failover function, the product ID and the synchronization data amount information.

To be more specific, the determination unit 362 determines whether or not the NAS including the determination unit 362 is stand-alone. Here, “stand-alone” means a state where no failover system is constructed between two NAS.

Moreover, the determination unit 362 determines whether or not the failover configuration specified by the version number extracted from the search packet can be realized. Here, the storage unit 320 holds the version number in the NAS including the storage unit 320 and one or more other version numbers, which can realize the failover configuration corresponding to the version number, while associating the version numbers with each other. When the version number extracted from the search packet is associated with the version number in the NAS including the determination unit 362, the determination unit 362 determines the NAS to be the one that can realize the failover configuration specified by the version number extracted from the search packet.

Furthermore, the determination unit 362 determines whether or not the hard disks 351 and 352 can construct the RAID configuration specified by the product ID extracted from the search packet. Additionally, the determination unit 362 determines whether or not the hard disks 351 and 352 can store the amount of data indicated by the synchronization data amount information while constructing the RAID configuration specified by the product ID extracted from the search packet.

The determination unit 362 determines the NAS including the determination unit 362 to be the one that can serve as the backup machine if all of the following four conditions are met: (1) the NAS including the determination unit 362 is stand-alone, (2) the failover configuration specified by the version number extracted from the search packet can be realized, (3) the hard disks 351 and 352 can construct the RAID configuration specified by the product ID extracted from the search packet, and (4) the hard disks 351 and 352 can store the amount of data indicated by the synchronization data amount information while constructing the RAID configuration specified by the product ID extracted from the search packet.

On the other hand, if any one of the above conditions (1) to (4) is not met, the determination unit 362 determines that the NAS including the determination unit 362 cannot serve as the backup machine. However, the condition (1) is not always essential. To be more specific, there maybe more than one main machine for one backup machine. However, when there are plural main machines for one backup machine, a failure rate can be increased by a shortage of storage capacity of the hard disk connected to the backup machine and by a load increase during writing to the hard disk. For this reason, this embodiment adopts the determination method unlikely to suffer from the above problem.

The response information transmission processor 363 transmits a determination result packet including the result of the determination by the determination unit 362 described above to the NAS 10 through the communication unit 310 and the communication network 60. In this embodiment, the determination result packet corresponds to the second response information.

The communication unit 110 in the NAS 10 receives the determination result packet and then outputs the packet to the controller 100. The response information reception processor 163 in the controller 100 receives the determination result packet.

The backup machine selector 164 analyzes the determination result packet from each of the NAS 30 to 50. When the determination result indicated by the determination result packet shows that the NAS can serve as the backup machine, the backup machine selector 164 selects the NAS as the source of the determination result packet as a new backup machine. Note that, when there is more than one determination result packet indicating the determination result that the NAS can serve as the backup machine, the backup machine selector 164 selects the NAS as the source of any one of the determination result packets as the new backup machine.

Furthermore, the backup machine selector 164 generates a backup selection packet indicating that the NAS has been selected as the backup machine. The backup selection packet includes synchronization information including information on settings to be synchronized between the main machine and the backup machine in the failover configuration, and directory information indicating the position of data to be synchronized. The backup machine selector 164 outputs the generated backup selection packet to the communication unit 110. The communication unit 110 transmits the backup selection packet to the NAS that is the new backup machine through the communication network 60.

Moreover, when each of the NAS 30 to 50 including the controller 300 is selected as a new backup machine, the controller 300 receives .a backup selection packet from the NAS 10 through the communication network 60 and the communication unit 310. Then, the controller 300 synchronizes the settings and data, based on the synchronization information included in the backup selection packet, so that each of the NAS 30 to 50 serves as the backup machine in the failover configuration.

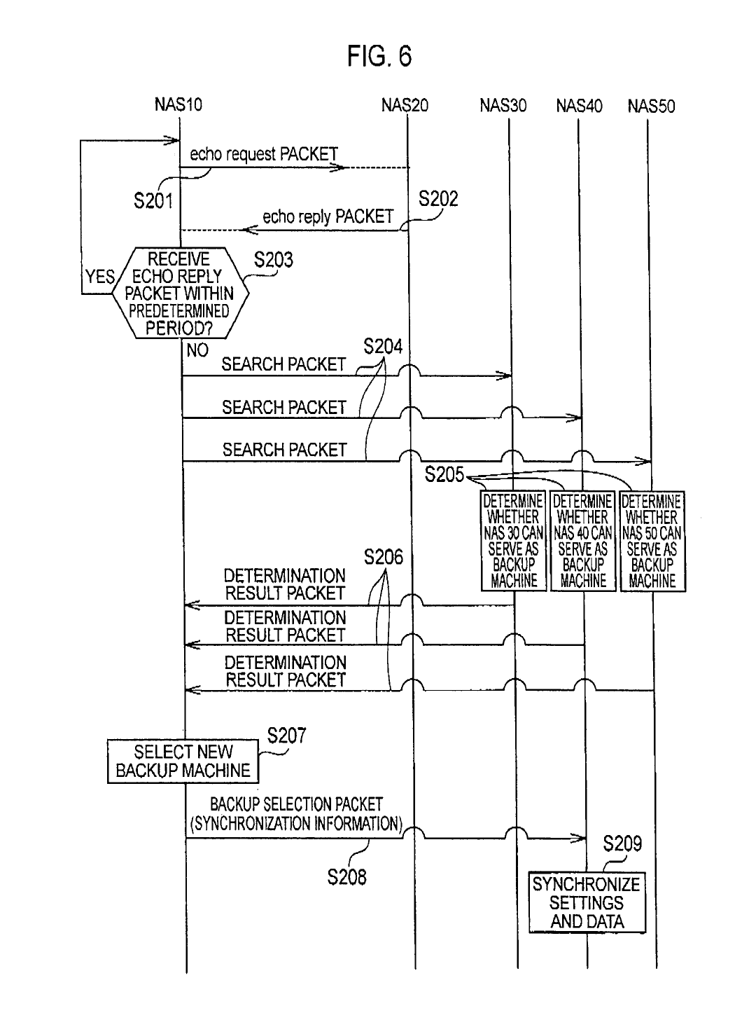

FIG. 6 is a sequence diagram showing a second operation of the failover system. In Step S201, the NAS 10 as the main machine transmits an echo request packet to the NAS 20 as the backup machine. Upon receipt of the echo request packet in Step S201, the NAS 20 transmits an echo reply packet to the NAS 10 in Step S202.

In Step S203, the NAS 10 determines whether or not it has received the echo reply packet in Step S202 within a predetermined period after transmitting the echo request packet in Step S201.

If the NAS 10 has received the echo reply packet within the predetermined period after transmitting the echo request packet, the operation after the transmission of the echo request packet in Step S201 is repeated.

On the other hand, if the NAS 10 has received no echo reply packet within the predetermined period after transmitting the echo request packet, the NAS 10 transmits, in Step S204, a search packet to each of the NAS 30 to 50 that can be candidates for the backup machine. Each of the NAS 30 to 50 receives the search packet.

In Step S205, each of the NAS 30 to 50 determines whether or not it can serve as the backup machine based on the RAID configuration information, storage capacity information and synchronization data amount information, which are included in the search packet.

In Step S206, each of the NAS 30 to 50 sends the NAS 10 a determination result packet indicating the result of the determination of whether or not it can serve as the backup machine. The NAS 10 receives the determination result packet.

In Step S207, the NAS 10 selects a NAS (here, the NAS 40) to be a new backup machine from among the NAS 30 to 50, based on a determination result indicated by a determination result packet.

In Step S208, the NAS 10 transmits a backup selection packet including synchronization information to the selected NAS 40. The NAS 40 receives the backup selection packet.

In Step S209, the NAS 40 synchronizes the settings and data for the NAS 40 to become the backup machine in the failover configuration, based on the synchronization information included in the backup selection packet.

In the failover system described above, when there is no response from the NAS 20, the NAS 10 as the main machine transmits a search packet for searching for a NAS to be a new backup machine. Upon receipt of the search packet, each of the NAS 30 to 50 determines whether or not it can serve as the backup machine, and then sends the NAS 10 a determination result packet indicating the determination result. The NAS 10 selects a NAS to be the new backup machine based on the determination result indicated by each determination result packet, and then transmits a backup selection packet to the selected NAS. The NAS that has received the backup selection packet synchronizes the settings and data for itself to become the backup machine in the failover configuration. Accordingly, the NAS 10 can select the NAS to be the new backup machine. Thus, the failover configuration can be easily constructed without depending on manpower.

Moreover, while the hard disks are connected to the NAS 10 to 50 in the above embodiment, storage media to be connected are not limited thereto. For example, storage media such as a SSD (Solid State Drive), a flash memory and an SD card may be connected.

As described above, this invention naturally includes various embodiments which are not described herein.

What is claimed is:

1. A failover system comprising:
a first storage processing device to which a storage medium is connectable;
a second storage processing device to which a storage medium is connectable, and which serves as a backup machine for the first storage processing device when a failure occurs in the first storage processing device; and
third storage processing devices to which storage media are connectable, and which are candidates for a backup machine, wherein
the first storage processing device comprises:
a presence confirmation information transmitter for transmitting, to the second storage processing device, presence confirmation information for confirming the presence of the second storage processing device;
a first response information receiver for receiving first response information that is a response to the presence confirmation information from the second storage processing device; and
a search information transmitter for transmitting search information for searching for the third storage processing devices when the first response information is not received within a predetermined period after the transmission of the presence confirmation information,
each of the third storage processing devices comprises:
a search information receiver for receiving the search information; and
a response information transmitter for transmitting second response information that is a response to the search information, and
the first storage processing device further comprises:
a second response information receiver for receiving the second response information from the third storage processing devices, and
a selector for selecting a backup machine from among the third storage processing devices based on the second response information received by the second response information receiver.

2. The failover system according to claim 1, wherein
the search information is information requesting transmission of at least any one of a function required to construct a failover configuration, a RAID configuration, and a storage capacity of a storage medium, and
the second response information includes at least any one of:
the function required to construct the failover configuration in a third storage processing device transmitting the second response information;
the RAID configuration in the third storage processing device; and
the storage capacity of the storage medium in the third storage processing device.

3. The failover system according to claim 1, wherein
the search information includes at least any one of a function required to construct a failover configuration, a RAID configuration, and the amount of data to be synchronized, and
the second response information includes determination result information that is a result of determination of whether a third storage processing device transmitting the second response information is operable as the backup machine, the determination being made based on at least any one of the function required to construct the failover configuration, the RAID configuration, and the amount of data to be synchronized.

4. A storage processing device to which a storage medium is connectable, and which serves as a main machine in a failover system, comprising:
a presence confirmation information transmitter for transmitting, to a first different storage processing device as a backup machine, presence confirmation information for confirming the presence of the first different storage processing device;
a first response information receiver for receiving first response information that is a response to the presence confirmation information from the first different storage processing device;
a search information transmitter for transmitting search information for searching for second different storage processing devices that are candidates for a backup machine when the response information is not received within a predetermined period after the transmission of the presence confirmation information;
a second response information receiver for receiving second response information that is a response to the search information from each of the second different storage processing devices; and
a selector for selecting a backup machine from among the second different storage processing devices based on the second response information received by the second response information receiver.

5. A storage processing device to which a storage medium is connectable, and which is a candidate for a backup machine in a failover system, comprising:
a search information receiver for receiving search information for searching for the own storage processing device from a different storage processing device; and
a response information transmitter for transmitting response information that is a response to the search information, the response information including at least any one of a function required to construct a failover configuration and a storage capacity of the storage medium in the own storage processing device, or including determination result information that is a result of determination of whether the on storage processing device is operable as the backup machine.

6. A failover control method in a storage processing device to which a storage medium is connectable, and which serves as a main machine in a failover system, comprising the steps of:
transmitting, to a first different storage processing device as a backup machine, presence confirmation information for confirming the presence of the first different storage processing device;
receiving first response information that is a response to the presence confirmation information from the first different storage processing device;
transmitting search information for searching for second different storage processing devices that are candidates for a backup machine when the response information is not received within a predetermined period after the transmission of the presence confirmation information;
receiving second response information that is a response to the search information from each of the second different storage processing devices; and
selecting a backup machine from among the second different storage processing devices based on the received second response information.

7. A failover control method in a storage processing device to which a storage medium is connectable, and which is a candidate for a backup machine in a failover system, comprising the steps of:
receiving search information for searching for the own storage processing device from a different storage processing device; and
transmitting response information that is a response to the search information, the response information including at least any one of a function required to construct a failover configuration and a storage capacity of the storage medium in the own storage processing device, or including determination result information that is a result of determination of whether or not the own storage processing device is operable as the backup machine.
